(19) United States
(12) Patent Application Publication
(10) Pub. No.: US 2019/0298047 A1
(43) Pub. Date: Oct. 3, 2019

(54) Magnetic Strap for Water Bottles

(71) Applicant: William Vanettes, Laverne, CA (US)

(72) Inventor: William Vanettes, Laverne, CA (US)

(21) Appl. No.: 16/239,384

(22) Filed: Jan. 3, 2019

Related U.S. Application Data
(60) Provisional application No. 62/652,122, filed on Apr. 3, 2018.

(51) Int. Cl. A45F 5/10

(52) U.S. Cl. CPC A45F 5/10; F16M 13/022

(57) ABSTRACT

A Magnetic Strap for Water Bottles. The strap has hook-and-loop (or other) fasteners in appropriate locations along it so that it can be wrapped around, and secured to a conventional bottle. Furthermore, the strap has one or more magnet assemblies on the outer surface of the strap so that the strap can be magnetically attached to an external metallic structure to thereby removeably secure the bottle to the external metallic structure.

This application is filed within one year of, and claims priority to Provisional Application Ser. No. 62/652,122, filed Apr. 3, 2018.

### BACKGROUND OF THE INVENTION

### 1. Field of the Invention

This invention relates generally to straps and harnesses and, more specifically, to a Magnetic Strap for Water Bottles.

### 2. Description of Related Art

Exercising has become a wide-spread activity for most young and middle-age adults. Fitness centers are therefore very popular, because an individual can exercise indoors on weight machines, treadmills, and otherwise engage with exercise apparatus.

Hydrating during exercise is of well-known importance in order to prevent dehydration. Consequently, most individuals have a bottle of water (or other liquid) at their side while they are exercising. This can sometimes prove to be a challenge, however, when the individual is exercising on a machine, such as a treadmill or the like. While many types of exercise equipment can have a built-in “cup holder” where the user can place his or her water bottle, these cup holders are not sized to hold every type of water bottle. If the bottle doesn't fit, or if there is no cup holder, then the user must either hold onto their bottle while exercising, or they usually are forced to place the bottle on the floor out of their reach from the exercise apparatus.

What is needed is a universal way of holding a water bottle within the user's reach while they are exercising—regardless of whether their bottle will fit in the existing cup holder.

### SUMMARY OF THE INVENTION

In light of the aforementioned problems associated with the prior devices and attachments, it is an object of the present invention to provide a Magnetic Strap for Water Bottles. The strap should have hook-and-loop fasteners in appropriate locations along it so that it can be wrapped around, and secured to a conventional bottle. Furthermore, the strap should have one or more magnet assemblies on the outer surface of the strap so that the strap can be magnetically attached to an external metallic structure to thereby removeably secure the bottle to the external metallic structure.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the magnetized strap of the present invention;

FIG. 2 is an exterior side view of the strap of FIG. 1;

FIG. 3 is an interior side view of the strap of FIG. 1;

FIG. 4 is a perspective view of the magnet assembly of the strap of FIG. 1; and

FIG. 5 is a perspective view of an example of a strap of the present invention attached to a conventional water bottle.

### DETAILED DESCRIPTION

### Of the Preferred Embodiments

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Magnetic Strap for Water Bottles.

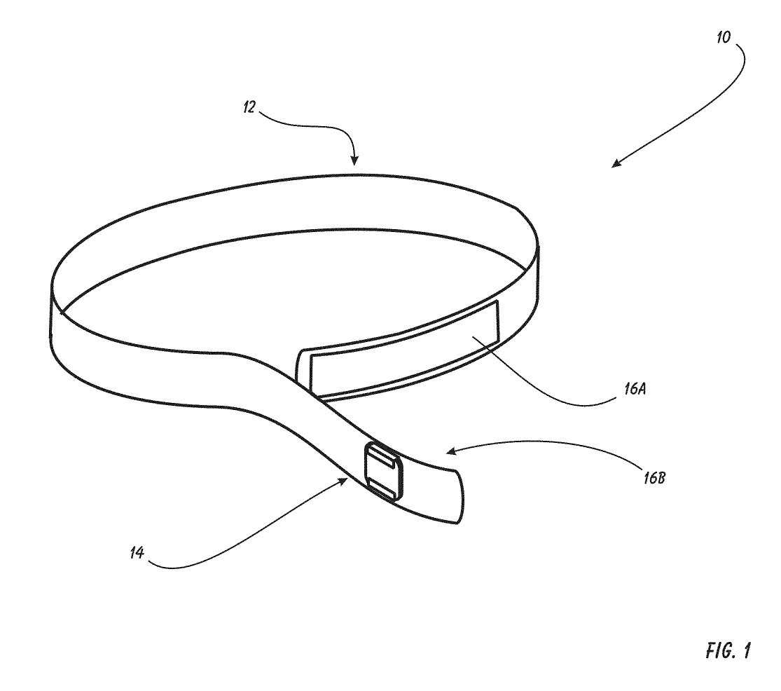

The present invention can best be understood by initial consideration of FIG. 1.¹ FIG. 1 is a perspective view of a preferred embodiment of the magnetized strap 10 of the present invention. The strap 10 is comprised of a elongate, flexible harness strap 12 made from durable material, such as a nylon mesh fabric. A magnet assembly 14 is attached to a portion of the strap 12. Here, it is in close proximity to one end of the strap 12, but it could be located anywhere (and on the inside or outside) of the strap. The magnet assembly 14 could be a single magnet, or it could be a plurality of magnet assemblies. A preferred type of magnet is one made from “neodynium” material because of the high strength of its magnetic field relative to its size. ¹ As used throughout this disclosure, element numbers enclosed in square brackets [ ] indicates that the referenced element is not shown in the instant drawing figure, but rather is displayed elsewhere in another drawing figure.

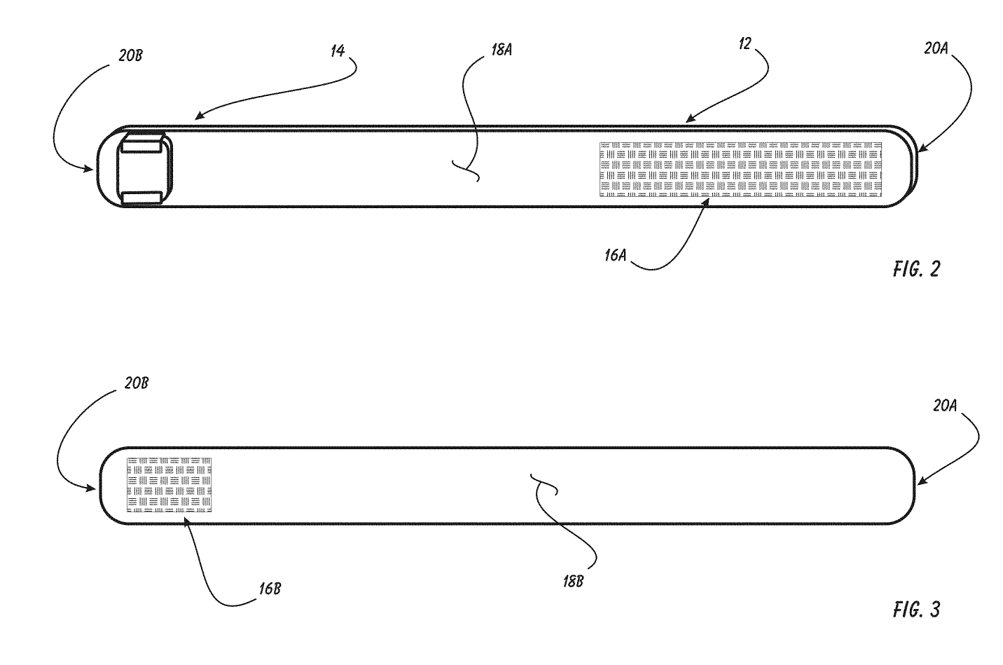

Fastener elements 16A and 16B are disposed at locations along the strap 12 so that they can be interlocked or attached to one another so that the harness strap 12 can be secured around a water bottle in a snug, closed loop. FIGS. 2 and 3 provide additional detail.

FIG. 2 is an exterior side view of the strap [10] of FIG. 1. In this example, the first fastener element 16A is attached to the exterior face 18A of the harness strap 12, near the inside tip 20A of the strap 12. A magnet assembly 14 is attached to the exterior surface 18A near the outside tip 20B of the strap 12. As shown in FIG. 3, a second fastener element 16B is attached to the interior face 18B of the strap 12, near the outside tip 20B.

In this example, the fastener elements 16A, 16B are individual components of a hook-and-loop fastener system. Other fastening systems may be optionally used, including snaps and clips, etc. to attach one end of the strap 12 to another portion of the strap 12.

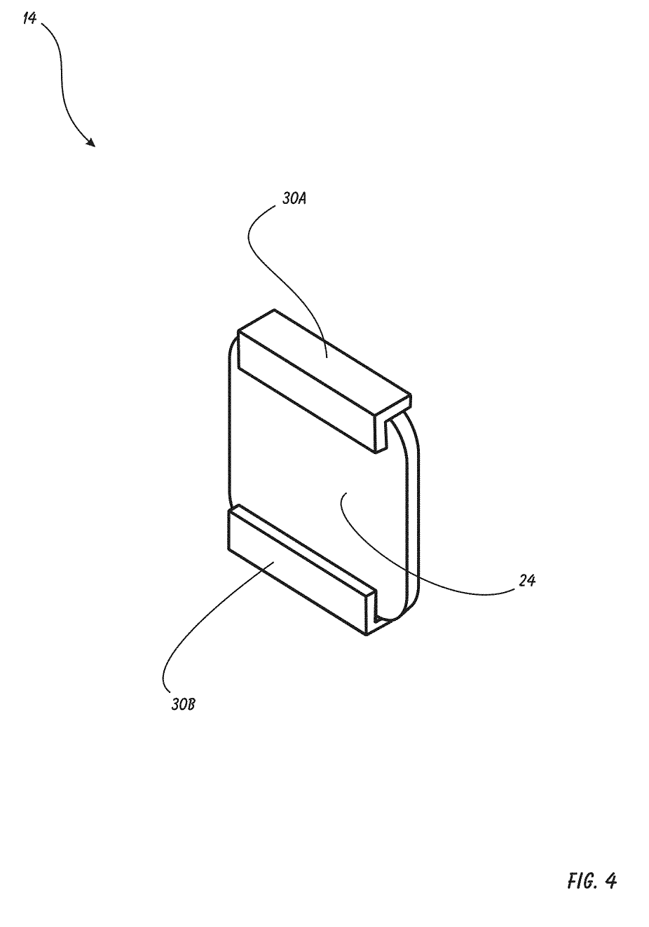

FIG. 4 is a perspective view of the magnet assembly 14 of the preferred design. The magnet assembly 14 preferably has a backing plate 22 of metal or other rigid material. The backing plate 22 provides structural rigidity and a solid connection with the strap [12]. One or more magnet elements 24A, 24B are adhered or otherwise permanently attached to the backing plate 22.

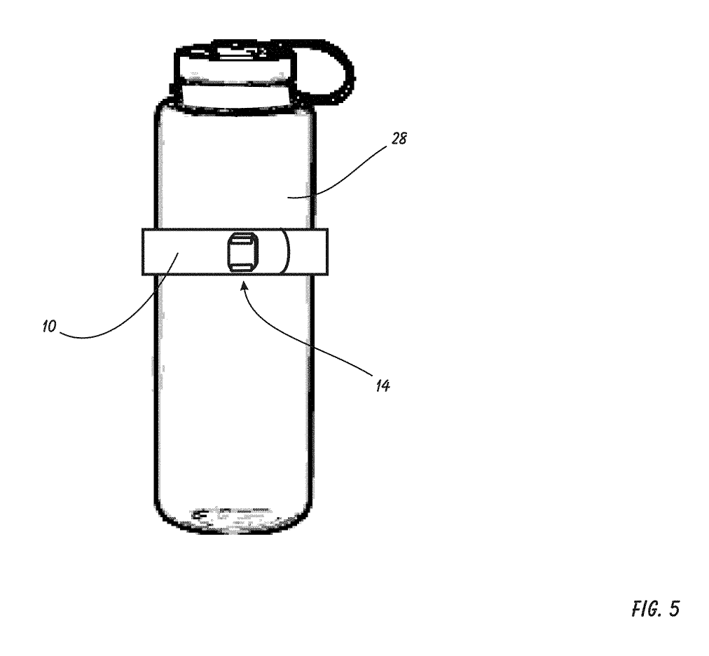

FIG. 5 is a perspective view of an example of a strap of the present invention attached to a conventional water bottle. Here, the strap 10 has been cinched tightly around the water bottle 28. Now, the user need only place the magnet element 14 against a metal portion of the exercise apparatus that he or she is using, and the strong magnetic field will hold the bottle 28 there so that the user can easily reach the bottle 28 for a drink whenever desired.

Those skilled in the art will appreciate that various adaptations and modifications of the just-described preferred embodiment can be configured without

departing from the scope and spirit of the invention. Therefore, it is to be understood that, within the scope of the appended claims, the invention may be practiced other than as specifically described herein.

What is claimed is:

1. A magnetic strap, comprising:
a elongate flexible strap defined by a pair of opposing ends, and inner and outer surfaces; and
a magnet assembly attached to said outer surface between said pair of opposing ends.

2. The magnetic strap of claim 1, wherein said elongate flexible strap further comprises a first fastener element disposed on said outer surface adjacent to one said end, and a second fastener element disposed on said inner surface adjacent to the other said end.

3. The magnetic strap of claim 2, wherein said first and second fastener elements comprise hook-and-loop fastener pads.

4. The magnetic strap of claim 2, wherein said magnet assembly comprises:
a magnet element attached to said outer surface; and
one or more protective elements attached to said magnet element.

5. The magnetic strap of claim 4, wherein said magnet element is attached to said outer surface at an inner surface defined by said magnet element, and each said protective element comprises a non-metallic element disposed on an outer surface of said magnet element.

6. The magnetic strap of claim 5, wherein each said protective element comprises an angled cross section, whereby a portion of each said protective element juxtaposes said outer surface of said magnet element and a portion of each said protective element juxtaposes an outer periphery of said magnet element.

7. The magnetic strap of claim 1, wherein said magnet element is attached to said outer surface at an inner surface defined by said magnet element, and each said protective element comprises a non-metallic element disposed on an outer surface of said magnet element.

8. The magnetic strap of claim 7, wherein each said protective element comprises an angled cross section, whereby a portion of each said protective element juxtaposes said outer surface of said magnet element and a portion of each said protective element juxtaposes an outer periphery of said magnet element.

9. A magnetic harness for bottles, comprising:
a elongate flexible strap defined by a pair of opposing ends, and inner and outer surfaces; and
a magnet assembly attached to said outer surface between said pair of opposing ends.

10. The harness of claim 9, wherein said elongate flexible strap further comprises a first fastener element disposed on said outer surface adjacent to one said end, and a second fastener element disposed on said inner surface adjacent to the other said end.

11. The harness of claim 10, wherein said first and second fastener elements comprise hook-and-loop fastener pads.

12. The harness of claim 10, wherein said magnet assembly comprises:
a magnet element attached to said outer surface; and
one or more protective elements attached to said magnet element.

13. The harness of claim 12, wherein said magnet element is attached to said outer surface at an inner surface defined by said magnet element, and each said protective element comprises a non-metallic element disposed on an outer surface of said magnet element.

14. The harness of claim 13, wherein each said protective element comprises an angled cross section, whereby a portion of each said protective element juxtaposes said outer surface of said magnet element and a portion of each said protective element juxtaposes an outer periphery of said magnet element.

15. The harness of claim 9, wherein said magnet element is attached to said outer surface at an inner surface defined by said magnet element, and each said protective element comprises a non-metallic element disposed on an outer surface of said magnet element.

16. The harness of claim 15, wherein each said protective element comprises an angled cross section, whereby a portion of each said protective element juxtaposes said outer surface of said magnet element and a portion of each said protective element juxtaposes an outer periphery of said magnet element.

17. A combination bottle and magnetic harness, comprising:
a bottle defined by a circumference having a length L; and
a harness, comprising:
an elongate flexible strap defined by a pair of opposing ends, inner and outer surfaces, and a length greater than L; and
an magnet assembly attached to said outer surface between said pair of opposing ends.

18. The combination of claim 17, wherein said magnet element is attached to said outer surface at an inner surface defined by said magnet element, and each said protective element comprises a non-metallic element disposed on an outer surface of said magnet element.

19. The combination of claim 18, wherein each said protective element comprises an angled cross section, whereby a portion of each said protective element juxtaposes said outer surface of said magnet element and a portion of each said protective element juxtaposes an outer periphery of said magnet element.

20. The combination of claim 19, wherein said elongate flexible strap further comprises a first fastener element disposed on said outer surface adjacent to one said end, and a second fastener element disposed on said inner surface adjacent to the other said end.
